(19) United States
(12) Patent Application Publication
(10) Pub. No.: US 2015/0066311 A1
(43) Pub. Date: Mar. 5, 2015

(54) METHOD AND SYSTEM FOR SAVING THE LIFE OF LIVING BEINGS REMAINING IN A VEHICLE

(71) Applicant: Marie Anne Schroeder, Hannover (DE)

(72) Inventor: Marie Anne Schroeder, Hannover (DE)

(73) Assignee: Robert Bosch GmbH, Stuttgart (DE)

(21) Appl. No.: 14/389,913

(22) PCT Filed: Feb. 8, 2013
(86) PCT No.: PCT/EP2013/052499

§ 371 Date: Oct. 1, 2014

(30) Foreign Application Priority Data
Apr. 2, 2012 (DE) 10 2012 205 334.2

(51) Int. Cl. B60H 1/00; B60Q 1/46; H04W 4/22; G05D 3/00

(52) U.S. Cl. CPC B60H 1/00742; G05D 3/00; B60H 1/008; B60Q 1/46; H04W 4/22
USPC 701/49; 701/36

(57) ABSTRACT

In a method for protecting living beings remaining behind in a vehicle, (i) it is recognized or detected whether a living being is inside the vehicle, (ii) it is recognized or detected whether the living being is in a health-endangered state, and (iii) rescue measures are initiated if the living being is in a health-endangered state.

### BACKGROUND OF THE INVENTION

1. Field of the Invention

The present invention relates to a method for protecting living beings remaining in a vehicle.

2. Description of the Related Art

From the published German patent application document DE 10 2004 024 284 A1, a method, a system and a device are known for executing danger-averting measures in a space inside a motor vehicle. Here, danger-averting measures are initiated in case of an increased carbon dioxide content of the ambient air and risen temperature, for example.

### BRIEF SUMMARY OF THE INVENTION

With the aid of the present invention, it is possible to protect and save the life of humans and/or animals that remain or were forgotten in a vehicle, using autonomous or networked functionalities.

The present invention relates to a method for protecting living beings remaining in a vehicle, in which
it is detected whether a living being is present inside the vehicle;
it is recognized or detected whether the living being is in a health-endangered state; and
rescue measures are initiated if the living being is in a health-endangered state.

One advantageous development of the present invention is characterized by the fact that the detection whether a living being is inside the vehicle is made by means of a motion detector, a camera and/or a measurement of the carbon dioxide content of the air inside the vehicle. In this context, it is possible to utilize sensor systems already installed in the vehicle, as the case may be.

One advantageous development of the present invention is characterized by the fact that the detection whether the living being is in a health-endangering state is made with the aid of a temperature measurement and/or an analysis of the air quality inside the vehicle. A health-endangering state is present in particular if the temperature exceeds a threshold value and/or if the air quality drops below a predefined quality. For example, this may be the case if the carbon dioxide concentration in the air exceeds a threshold value or if a lack of oxygen is prevailing inside the vehicle.

In one advantageous refinement of the present invention, at least one of the following measures is provided as rescue measure:
a warning is issued when another person exits and/or locks the vehicle, and/or
a window or the sunroof is opened at least partially; and/or
an air conditioning system or ventilation system is set to an external air supply; and/or
the vehicle environment is alerted to the health-endangered living being in the vehicle by an alarm signal or the hazard lights; and/or
a distress call is transmitted to the vehicle driver, the vehicle owner, rescue units and/or other vehicles with the aid of networked functionalities.

Depending on the application, one of these rescue measures may be triggered, but it is also possible to execute several of these rescue measures in multiple escalation stages, one after the other.

For this reason one advantageous further development of the present invention is characterized by the fact that at least two different safety measures are executed in an escalating manner. In particular, an emergency ventilation of the vehicle interior may be carried out as a first step, and if this turns out to be unsuccessful, additional measures will be taken.

One advantageous further development of the present invention is characterized by the fact that a window or the sunroof is at least partially opened as a first rescue measure, and/or an air-conditioning system or ventilation system is switched to an external air supply; if this does not remedy the health-endangering state, an alarm signal or the hazard lights alerts the vehicle environment to the heath-endangered living being inside the vehicle, and/or an emergency call is transmitted to the vehicle driver, the vehicle owner, rescue units and/or other vehicles with the aid of networked functionalities. The emergency call may be made to the land line, the mobile telephone or the PC of the vehicle driver or vehicle owner, for example.

Furthermore, the present invention includes a device which includes means designed to implement the methods of the present invention. In particular, this is a control unit, in which software is stored that is required to execute the present invention.

### BRIEF DESCRIPTION OF THE DRAWING

FIG. 1 shows the basic sequence of the method of the present invention.

### DETAILED DESCRIPTION OF THE INVENTION

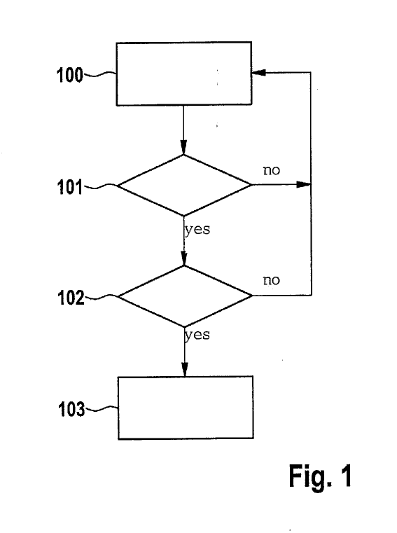

Following the start in block 100 in FIG. 1, a query is made in block 101 as to whether a living being is inside the vehicle. This may be a person, such as a young child, but also an animal. If this is the case, the method proceeds to block 102; if this is not the case, a return to the start of the method takes place. In block 102, it is queried whether the living being is in a health-endangered state. If this is the case, safety measures or rescue measures are triggered in block 102. This could be an individual measure but, depending on the severity of the health risk, also a stepped block of measures. If this is not the case, the method returns to the start of the method.

1-7. (canceled)

8. A method for protecting a living being remaining in a vehicle, comprising:
detecting whether a living being is present inside the vehicle;
detecting whether the living being is in a health-endangered state; and
initiating at least one remedial measure if the living being is in the health-endangered state.

9. The method as recited in claim 8, wherein the detection of whether a living being is inside the vehicle is made by at least one of a motion detector, a camera and a measurement of carbon dioxide content of the air inside the vehicle.

10. The method as recited in claim 8, wherein the detection of whether the living being is in a health-endangered state is made with the aid of at least one of a temperature measurement inside the vehicle and an analysis of the air quality inside the vehicle.

11. The method as recited in claim 8, wherein the at least one remedial measure includes at least one of:
a warning which is issued upon one of (i) a passenger exiting the vehicle, or (ii) locking of the vehicle;
at least a partial opening of one of a window or a sunroof;
setting one of an air conditioning system or ventilation system to an external air supply;
activating one of an alarm signal or a hazard light to signal to the vehicle environment the presence of the health-endangered living being in the vehicle; and
transmitting a distress call to at least one of a vehicle driver, a vehicle owner, a rescue unit and another vehicle with the aid of networked communication apparatus.

12. The method as recited in claim 11, wherein at least two different safety measures are executed in an escalating manner

13. The method as recited in claim 11, wherein:
as a first rescue measure, at least one of the following is performed: (i) one of the window or the sunroof is at least partially opened; and (ii) one of an air-conditioning system or ventilation system is set to an external air supply; and
if the first rescue measure does not remedy the health-endangering state, at least one of the following is performed as a second rescue measure: (iii) activating one of an alarm signal or a hazard light to signal to the vehicle environment the presence of the health-endangered living being in the vehicle; and (iv) transmitting a distress call to at least one of a vehicle driver, a vehicle owner, a rescue unit and another vehicle with the aid of networked communication apparatus.

14. A device for protecting a living being remaining in a vehicle, comprising:
means for detecting whether a living being is present inside the vehicle;
means for detecting whether the living being is in a health-endangered state; and
means for initiating at least one remedial measure if the living being is in the health-endangered state.
